(19) United States
(12) Patent Application Publication
(10) Pub. No.: US 2015/0145431 A1
(43) Pub. Date: May 28, 2015

(54) VOLTAGE-CONTROLLED DIMMING OF LED-BASED LIGHT MODULES COUPLED IN PARALLEL TO A POWER SUPPLY

(71) Applicant: Lumenetix, Inc., Scotts Valley, CA (US)

(72) Inventor: Herman Ferrier, Scotts Valley, CA (US)

(21) Appl. No.: 14/555,318

(22) Filed: Nov. 26, 2014

Related U.S. Application Data
(60) Provisional application No. 61/909,934, filed on Nov. 27, 2013.

(51) Int. Cl. H05B 33/08

(52) U.S. Cl. CPC H05B 33/0845; H05B 33/0809
USPC 315/210; 315/294

(57) ABSTRACT

Some embodiments include a LED-based light module. The LED-based light module can include a memory to store a color mixing plan; a regulator that receives a variable output voltage from a power supply; a voltage measurement component, coupled in parallel to the regulator and the power supply, configured to measure a voltage level of the variable output voltage; a logic component; and a driver circuit. The logic component can be configured to determine driving current profiles for LEDs in the LED-based light module to dim a light output of the LEDs based on the voltage level. The driver circuit can drive the LEDs according to the driving current profiles by drawing power from the power supply (e.g., through the regulator).

### CROSS-REFERENCE TO RELATED APPLICATION(S)

This application claims the benefit of U.S. Provisional Patent Application No. 61/909,934, entitled “VOLTAGE CONTROLLED DIMMING OF LED-BASED LIGHTING UNITS COUPLED IN PARALLEL TO A POWER SUPPLY,” which was filed on Nov. 27, 2013, which is incorporated by reference herein in its entirety.

### TECHNICAL FIELD

At least one embodiment of this disclosure relates generally to a light dimming system, and in particular to digitally controlled light dimming.

### BACKGROUND

Dimmers, such as phase-controlled TRIAC (triode for alternating current), are commonly used to adjust the intensity of light provided by conventional light modules, such as incandescent light bulbs, which are resistive loads. For example, depending on the setting of the dimmer, it blocks part of the 120V root mean square (RMS) alternating current (AC) waveform provided by the electrical utility grid. As a result, the power delivered to the resistive load is proportional to the non-blocked section of the full AC waveform that reaches the resistive load. A conventional light module can be dimmed over a wide range of intensities with the dimmer. However, light emitting diode (LED)-based light modules are not simple resistive loads, and thus, a conventional dimmer does not dim an LED as with a resistive load light module. Rather, the dimmer causes flickering of the light produced.

### BRIEF DESCRIPTION OF THE DRAWINGS

Examples of a dimming system for LED-based light modules are illustrated in the figures. The examples and figures are illustrative rather than limiting.

FIG. 1 is a block diagram illustrating a dimming system, in accordance with various embodiments.

FIG. 2 is a graph diagram illustrating three examples of dimming phases corresponding to power supply outputs, which in turn controls a LED-based light module, in accordance with various embodiments.

FIG. 3 is a block diagram of a LED-based light module, in accordance with various embodiments.

FIG. 4 is a flow chart of a method of operating a LED-based light module, in accordance with various embodiments.

The figures depict various embodiments of this disclosure for purposes of illustration only. One skilled in the art will readily recognize from the following discussion that alternative embodiments of the structures and methods illustrated herein may be employed without departing from the principles of embodiments described herein.

### DETAILED DESCRIPTION

A dimmer, e.g. a TRIAC dimmer or a variable resistor, is used to control and limit the output voltage of a power supply to a predetermined range. Several embodiments include a LED-based light module that is coupled in parallel to the output of a power supply. Adjustments to the light output (e.g., dimming, color temperature adjustment, switching between preset color configurations, or warm dimming) of the LED-based light module is configured to be a function (e.g., linearly proportional, logarithmically proportional, or proportional according to another mathematical formula) of the output voltage of the power supply. The preset color configurations can include preset characteristics, such as hue, color temperature, saturation, intensity, or any combination thereof. The dimmer can adjust the output voltage of the power supply continuously or in discrete amounts. The adjustments can be continuous or discrete. The adjustments of the light output can be controlled by a logic component (e.g., a digital or analog logic component) that receives a measurement of the output voltage of the power supply (e.g., varying input voltage of the LED-based light module). In some embodiments, the logic component can implement the function to adjust the light output characteristics in a discrete manner (e.g., where an absolute voltage level corresponds to a preset light output characteristic) when the dimmer adjusts the output voltage of the power supply in a continuous manner. In some embodiments, the logic component can implement the function to adjust the light output characteristics in a continuous manner when the dimmer adjusts the output voltage of the power supply in a discrete manner.

This feature enables a dimmer to effectively control the light output intensity (e.g., brightness) or other light characteristic (e.g., light color hue or color temperature) of the LED-based light module. In some embodiments, a single dimmer can control the light output intensity of multiple LED-based light modules.

Several embodiments include designing the LED-based light module to operate over a range of direct current (DC) input voltages (e.g., the power supply's output voltages). As an example, this range can be 10V to 15V for a 12V nominal voltage power supply, or 20V to 30V for a 24V nominal voltage power supply. The LED-based light module is designed with a driver circuit coupled to the DC input voltage (e.g., the power supply's output voltage) such that, without an added logic to the logic component, varying the input voltage of the power supply over the range does not cause any change in LED dimming or Correlated Color Temperature (CCT). This range can be referred to as the voltage invariant rang (VIR).

The disclosed dimmer is a human adjustable dimmer coupled to the input of the power supply. The dimmer adjusts a voltage level of the power supply, where the voltage level is proportional to the desired amount of adjustment (e.g., dimming or CCT change). The voltage level can lie within the VIR. For example, for the nominal 12V power supply, the voltage of 10V can represent 100% dimming and 15V 0% dimming. The voltage between these two extremes of the VIR is proportional to the desired amount of dimming % or CCT value, following a linear, exponential or other type of mathematical curve. In some embodiments, the varying input voltage of the LED-based light module is measured by a voltage measurement component (e.g., an input amplifier section), and processed by the logic component to provide the requisite currents driving the LEDs (e.g., LED strings) so that the LED-based light module adjusts its light output according to the desired light characteristic (e.g., dimming level or CCT value) as the function of the varying input voltage.

In some embodiments, the LED-based light module includes an amplifier circuit that reads the output voltage of the power supply utilizing a voltage measurement component and determines current profiles to drive LEDs (e.g., of different colors or the same color) in the LED-based light module. The amplifier circuit is configured such that the determined current profiles drives the LEDs to produce a light intensity or light color (e.g., light color hue or color temperature) that is a function of the output voltage of the power supply.

In some embodiments, the LED-based light module controls electric currents to drive different LEDs (e.g., of different colors or the same color), such as according to a color mixing plan to consistently produce an intended spectral output (i.e., intended light output) under different operating conditions (e.g., operating temperature or operating voltage) and performance metric constraints. The color mixing plan can be a computed model specific to a LED-based light module. For example, a spectral analyzer or other optical sensors can measure spectral outputs of a LED-based light module during manufacturing under various operating conditions. A computing system can then compute sets of optimal current driving profiles to achieve specific color characteristics utilizing the LEDs in the LED-based light module under sets of operating conditions and performance metric constraints. For example, the color mixing plan can ensure a certain level of energy efficiency, efficacy, or color rendering index (CRI) when producing spectral output (i.e., light output) at different correlated color temperatures (CCT), saturation, brightness/intensity, contrast, hue, or any combination thereof. The color mixing plan can be expressed as a lookup table or one or more parametric equations associating the sets of the current driving profiles to the sets of operating conditions(s) and/or performance metric constraints.

Color mixing from multiple color LEDs enables the LED-based light modules to emulate the spectral output patterns of natural sunlight and conventional incandescent lights despite at least some of the color LEDs having narrow wavelengths. The color LEDs can include white color LEDs. Digital control of LED-based light modules using a color mixing plan (e.g., a computed model) accounts for variations in component LEDs in a LED-based light module such that the intended spectral output of that LED-based light module is consistent with spectral outputs of other LED-based light modules controlled in this fashion.

Several embodiments of a dimming system include a dimmer (e.g., an ordinary or conventional dimmer), a power supply selected to operate within a limited range, and a LED-based light module that draws power from the power supply and measures an output voltage of the power supply. The output voltage of the power supply is connected in parallel to the LED-based light module as its input voltage.

In some embodiments, an amplifier circuit of the LED-based light module can take input from the output voltage of the power supply and determine current profiles to drive the LEDs as a function of the measured output voltage of the power supply. In some embodiments, a logic component (e.g., a processor, a controller, or a transistor circuit) of the LED-based light module can adjust current drivers despite variations in the input voltage (e.g., according to the color mixing plan such that the intended spectral output is consistently produced). In some embodiments, the logic circuit is an analog logic circuit, such as the amplifier circuit. The logic component further uses the measured output voltage (e.g., the input voltage of the LED-based light module) of the power supply to compute current profiles to drive the LEDs of the LED-based light module. The computer current profiles can drive the LEDs such that the mix light produced from the LEDs produce intensity levels (e.g., discrete intensity levels) or light color characteristic (e.g., light color hue or color temperature) as a function (e.g., proportional) of the measured output voltage.

In some embodiments, the logic component can enforce other optical or electrical criteria while dimming. These criteria can include a performance metric (e.g., efficiency, efficacy, color rendition index (CRI), or any combination thereof). In some embodiments, the logic component can implement a “warm dimming” that is a function (e.g., proportional) of the output voltage of the power supply. Warm dimming is a process of dimming the spectral output of the LED-based light module along a correlated color temperature (CCT) curve. For example, warm dimming can emulate changes in color temperature of a black body emitter (e.g., the sun) when its brightness/spectral intensity changes.

In this disclosure, “dimming” refers to the act of adjusting a light output intensity or brightness. This includes adjusting to increase the light output intensity or brightness or to decrease the light output intensity or brightness. Likewise, a dimmer refers to a device having a human interface component for a person to indicate an intended level of light output intensity or brightness from a light module.

Various dimmers can be used in the dimming system. In several embodiments, a TRIAC dimmer is used as an example to illustrate how to control an output voltage of a power supply and how to control the intensity of one or more LED-based light modules using the output voltage of the power supply. However, other types of dimmers can be used as well.

Various aspects and examples will now be described. The following description provides specific details for a thorough understanding and enabling description of these examples. One skilled in the art will understand, however, that various embodiments may be practiced without many of these details. Additionally, some well-known structures or functions may not be shown or described in detail, so as to avoid unnecessarily obscuring the relevant description.

The terminology used in the description presented below is intended to be interpreted in its broadest reasonable manner, even though it is being used in conjunction with a detailed description of certain specific examples of the technology. Certain terms may even be emphasized below; however, any terminology intended to be interpreted in any restricted manner will be overtly and specifically defined as such in this Detailed Description section.

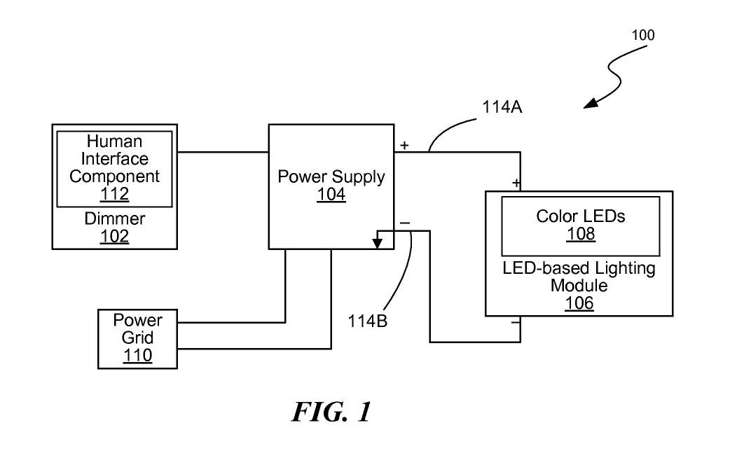

FIG. 1 is a block diagram illustrating a dimming system 100, in accordance with various embodiments. The dimming system 100 includes a dimmer 102, the power supply 104, and a LED-based light module 106. The LED-based light module 106 can include one or more LEDs 108. In some embodiments, the LEDs 108 are of different colors (e.g., red, green, yellow, blue, and/or white). In some embodiments, the LEDs 108 are of the same color. For example, the spectrums produced from the different color LEDs can be mixed inside a mixing chamber and/or a light pipe of the LED-based light module 106. The ability to mix these colors enable the LED-based light module 106 to produce a light output that covers a wide range of optical characteristics (e.g., color temperature, intensity, hue, saturation, or any combination thereof).

The power supply 104 can output power as a variable direct current (DC) voltage to the LED-based light module 106. The power supply 104 can be coupled to a power grid 110 the provides an alternating current (AC). For example, the power grid 110 can provide a RMS voltage of 120V at 60 Hz. The power grid 110 can provide a hot wire and a neutral wire. In some embodiments, the power grid 110 can also carry a ground wire that connects to an electric earth ground as a protection against faults.

The dimmer 102 is a device used to lower or increase the voltage output of the power supply 104. For example, the dimmer 102 can be a variable resistor or a silicon control rectifier (SCR). A variable resistor would dissipate power as heat and acts as a voltage divider. The SCR can switch between a low resistance “on” state and a high resistance “off” state and thus dissipating the power compared to the controlled load.

The dimmer 102 can have a human interface component 112. The dimmer 102 is configured to control the variable output voltage (e.g., between a positive terminal 114A and a negative terminal 114B) of the power supply 104 within a limited range. The variable output voltage can be a function (e.g., linearly proportional or logarithmically proportional) of an extent of human interaction via the human interface component 112. In some embodiments, the human interface component 112 is a slider and the extent of the human interaction is measured as a position of the slider along a rail of the slider. In some embodiments, the human interface component 112 is a knob and the extent of the human interaction is measured as an amount of radial rotation of the knob.

The LED-based light module 106 can be configured to compute current profiles for driving the LEDs 108, such as according to a color mixing plan. The color mixing plan is a pre-computed model to dictate driving current profiles to produce intended lighting characteristics. In some embodiments, the color mixing plan is generated during a manufacturing stage of the LED-based light module 106. The color mixing plan can be stored in a memory (e.g., a flash memory or a read-only memory) of the LED-based light module 106.

In some embodiments, the LED-based light module 106 includes an electronic circuitry (e.g., including a logic component or an amplifier circuit) to control driving currents supplied to the LEDs 108 (e.g., via a driver circuit). The electronic circuitry can have an operating range that matches the limited range of the power supply. The LED-based light module 106 can be configured to control (e.g., digitally or via an analog circuit, such as an amplifier circuit) the current profiles such that electric currents drawn from the power supply 104 cause the LEDs 108 to produce a light output having an intensity or color characteristic that is a function (e.g., linearly proportional, logarithmically proportional, or proportional according to another mathematical formula) of the variable output voltage of the power supply 104 as measured at the LED-based light module 106.

In some embodiments, the function can map discrete voltage steps that correspond to preset color characteristics. For example, the dimmer 102 can be push-button dimmer, a slider or a pot (e.g., potentiometer). The voltage steps of the power supply 104 may be activated by the push-button preset voltages or by analog voltages produced by a slider or a pot. In some embodiments, the dimmer 102 includes a push-button section that can cause the power supply to generate voltage steps and a linear voltage section that is activated by a slider.

For example, the LED-based light module 106 can include a regulator and a voltage measurement component. The regulator and the voltage measurement component can both be coupled in parallel to the variable output voltage. For example, the regulator can be coupled to a power rail that provides power to a logic component (e.g., a processor, a controller, or a transistor circuit) or an amplifier circuit of the LED-based light module 106. The power rail can also provide power to drive the LEDs 108. In some embodiments, the voltage measurement component is an analog to digital converter. In some embodiments, the voltage measurement component is a voltage divider and/or a transistor.

The dimmer 102 controls the variable output voltage of the power supply 104 so that the variable output voltage stays within the limited range. In some embodiments, the limited range of the power supply 104 has a minimum limit selected to match has a minimum voltage below which the variable output voltage is incapable of sustaining an electronic circuitry of the LED-based light module 106 in an operational mode to drive the LEDs 108. In some embodiments, the minimum limit is selected to match a minimum voltage below which the variable output voltage is incapable of driving the LEDs 108 to cover an adjustable color space. In some embodiments, the minimum limit is selected to match a minimum voltage below which the variable output voltage is incapable of keeping the logic component of the LED-based light module 106 in an operational mode.

In some embodiments, the limited range of the power supply 104 has a maximum limit selected to match has a maximum voltage beyond which the logic component of the LED-based light module 106 has a substantial likelihood of malfunction (e.g., short-circuiting or burning out). In some embodiments, the maximum limit is selected to match a maximum voltage be out which at least one of the LEDs 108 has a substantial likelihood of malfunction (e.g., short-circuiting or burning out).

As a specific example, the LED-based light module 106 can operate with an input voltage between 20V and 30V. The power supply 104 can be designed such that, when the dimmer 102 is off (e.g., zero phase dimming) and a full sine wave input waveform drives the power supply 104, the power supply 104 provides a DC output of 30V. When the dimmer 102 is operating with high phase dimming to block most of the input sine wave, the power supply 104 can provide a DC output of 20V. The LED-based light module 106 can be coupled in parallel to the output of the power supply 104. The LED-based light module 106 can operate at maximum current when the voltage input (e.g., the variable output voltage of the power supply 104) to the LED-based light module 106 is 30V. The LED-based light module 106 can operate at minimum current when the voltage input to the LED-based light module 106 is 20V.

In some embodiments, the output of the power supply 104 can provide 20V DC at zero phase dimming and 30V DC at high phase dimming. In this case, the LED-based light module 106 coupled in parallel to the output of the power supply 104 can operate at maximum current when the voltage input to the LED-based light module 106 is 20V and at minimum current when the voltage input to the light module is 30V. That is, the intensity of the light output of the LED-based light module 106 can be inversely proportional to the output voltage of the power supply 104. In this disclosure, “proportional” refers to consistent adjustment based on a mathematical formula. For example, being “proportional” can refer to positively proportional or inversely proportional. Being “proportional” can be linearly proportional or non-linearly proportional. While the limited range of 20V to 30V is chosen for this example, the limited range of the power supply 104 can be designed according to the requirements of the LED-based light module 106 to be driven.

In some embodiments, the dimmer 102 is a phase dimmer and the variable output voltage is proportional to a dimming phase of the dimmer 102. In some embodiments, the dimmer 102 is a reverse phase dimmer. In some embodiments, the dimmer 102 includes a triode for alternating current (TRIAC) and the dimming phase of the dimmer 102 is proportional to the extent of the human interaction. For example, the variable output voltage can be linearly proportional to the dimming phase.

By controlling the intensity,color, or other light output characteristic of the LED-based light module 106 with the output voltage of the power supply 104, the output voltage can both provide power to the LED-based light module 106, and carry information to the LED-based light module 106. In some embodiments, because the LED-based light module 106 is coupled in parallel to the power supply 104, multiple light modules can be coupled to and be controlled by the power supply 104. Upon sensing the output voltage of the power supply 104, all of the light modules can adjust their output intensities or output colors accordingly. Accordingly, in various embodiments, no additional communication link besides the power lines of the power supply 104 is needed between the power supply 104 and the light modules to control the light output intensities of the light modules.

“This function may include voltage steps which act as presets. These steps may be activated by push-button preset voltages or by analog voltages produced by a slider or pot. An alternative could be a combination of some preset steps that are push-button activated and a linear voltage section that is activated by the slider.”

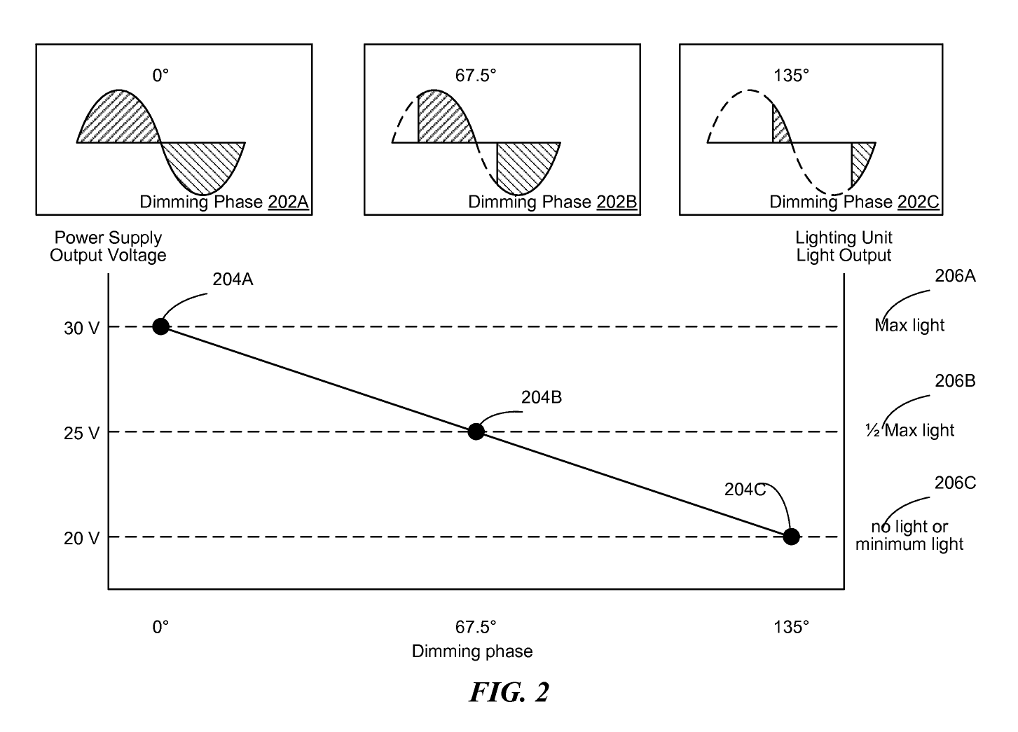

FIG. 2 is a graph diagram illustrating three examples of dimming phases corresponding to power supply outputs, which in turn controls a LED-based light module (e.g., the LED-based light module 106 of FIG. 1), in accordance with various embodiments. The dimming phases can include dimming phase 202A, dimming phase 202B, and dimming phase 202C, collectively as the “dimming phases 202.” The dimming phases correspond to phases of a dimmer (e.g. the dimmer 102 of FIG. 1), such as a TRIAC dimmer. The power supply outputs can include a power supply output 204A, a power supply output 204B, and a power supply output 204C, collectively as the “power supply outputs 204.” The light module outputs can include spectral intensity 206A (e.g., 100% maximum intensity), spectral intensity 206B (e.g., 50% maximum intensity), and spectral intensity 206C (e.g., minimum intensity or 0% maximum intensity), collectively as the “light module outputs 206.”

The dimming phases 202 are represented as the AC waveforms that the dimmer allows to pass to drive a power supply (e.g., the power supply 104 of FIG. 1). The dimming phase 202A can be at 0°, the dimming phase 202B can be at 67.5°, and the dimming phase 202C can be at 135°. At the dimming phase 202A, the TRIAC dimmer allows an entire AC sine wave (e.g. from a power grid, such as the power grid 110 of FIG. 1) to pass. For a dimming phase of 180° (not shown), the dimmer can block the entire AC sine wave. However, if the entire input sine wave were blocked, there would be no input to the power supply and, thus, the power supply would not generate any voltage. Thus, the dimming phase 202C at 135° can be selected to correspond to a maximum dimming. At the dimming phase 202C, a small portion of the AC sine wave is not blocked, and hence enabling the power supply to generate a positive DC output voltage. In this example, the DC output voltage of the dimming phase 202C is the power supply output 204C at 20V. Having a positive DC output voltage at the maximum dimming enables the LED-based light module to sustain its operations (e.g., to keep a microprocessor running).

For another example, half of the dimming phase 202C is the dimming phase 202B at 67.5°. For the dimming phase 202B, the output voltage of the power supply is designed to be halfway between 30V and 20V, namely at 25V. For this case, the output voltage of the power supply is designed to be linear and inversely proportional to the dimming phase of the dimmer.

Because the LED-based light module can be coupled in parallel to the output of the power supply, more than one light module can be driven simultaneously by the power supply. This is useful in the case of track lighting where multiple light modules are powered in parallel.

In the illustrated example, as shown by the graph at the bottom of FIG. 2, each of parallel light modules coupled to the power supply can output its maximum light output intensity when it detects that the output voltage of the power supply is the power supply output 204A at 30V, corresponding to the dimming phase 202A (e.g., a zero phase dimming) of the dimmer. When the output voltage decreases to 25V at the power supply output 204B, corresponding to the dimming phase 202B, each parallel light module can detect the output voltage and correspondingly reduces its light output intensity to half of its maximum value. When the output voltage decreases to 20V, corresponding to the dimming phase 202C, each of the light modules can detect the minimum voltage of the limited range and reduces its light output intensity to its minimum output intensity (e.g., no light output at all or a minimum light output).

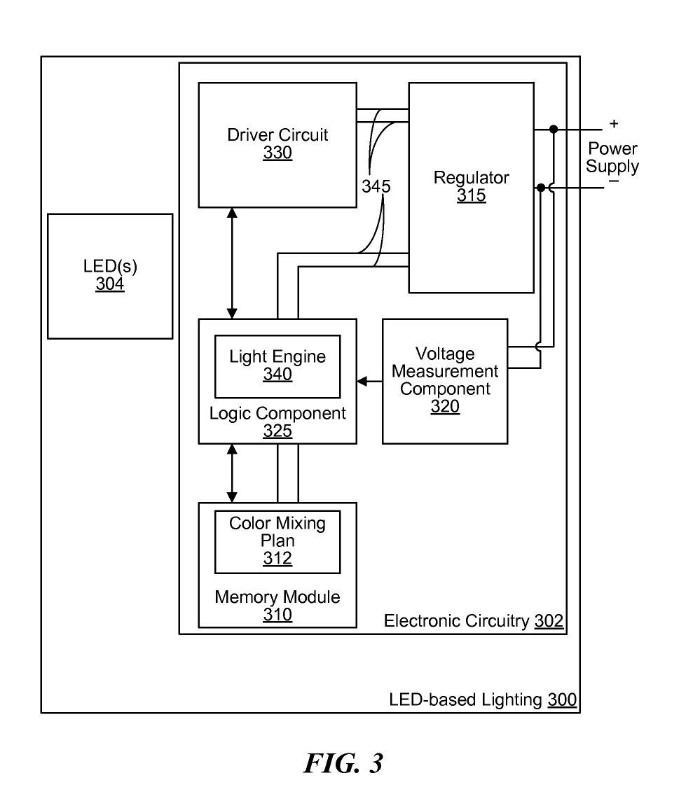

FIG. 3 is a block diagram of a LED-based light module 300, in accordance with various embodiments. The LED-based light module 300 can include an electronic circuitry 302 for driving LEDs 304. The LEDs 304 can include two or more color strings, each color strings having one or more LEDs of substantially the same color. The two or more color strings can have different colors. The electronic circuitry 302 can include a memory module 310, a regulator 315, a voltage measurement component 320, a logic component 325, a driver circuit 330, or any combination thereof.

The memory module 310 can be a volatile or nonvolatile memory. A volatile memory module can be a “non-transitory” memory in the sense that it is not transitory signal. The memory module 310 can be a random access memory, a persistent memory, a read only memory, or any combination thereof. The memory module 310 can store a color mixing plan 312. The color mixing plan 312 is a set of associations that specify multiple sets of driving current profiles respectively for driving the LEDs to achieve different spectral output characteristics (e.g., color temperature, hue, saturation, intensity/brightness, or any combination thereof) under different operational conditions (e.g., input voltage level and operating temperature) and given different constraints of performance metric constraints (e.g., CRI, efficiency, brightness, efficacy, or any combination thereof).

The regulator 315 is adapted to receive a variable output voltage from a power supply (e.g., the power supply 104 of FIG. 1). The regulator 315 is adapted to provide stable power to components of the electronic circuitry 302 and the LEDs 304 that coupled to the electronic circuitry 302.

The voltage measurement component 320 can be an analog to digital converter, a transistor, a voltage divider, or any combination thereof. The voltage measurement component 320 can be coupled to the power supply in parallel to the regulator 315. The voltage measurement component 320 can be configured to measure a voltage level of the variable output voltage from the power supply. For example, the voltage measurement component 320 can convert an analog output voltage of the power supply to a digital value.

The logic component 325 can be a processor, a controller, or an analog logic circuit (e.g., an amplifier circuit). The logic component 325 can be powered via the regulator 315. The logic component 325 can be configured to receive the measured voltage level from the voltage measurement component 320. In various embodiments, the logic component 325 can configure the driver circuit 330 to provide current levels to the LEDs 304 that produces an intensity or color (e.g., color temperature or hue) as a function of the measured voltage level. In some embodiments, the function can map discrete or continuous voltage levels to discrete adjustments of the current levels corresponding to preset light output characteristics. In some embodiments, the function can map discrete or continuous voltage levels to continuous adjustment of the current levels corresponding to a dimension of light output characteristic (e.g., brightness or color temperature).

In some embodiments, the logic component 325 can implement a light engine 340 to adjust electric currents driving the LEDs 304 via the driver circuit 330 according to the color mixing plan 312. The driver circuit 330 can drive the color strings according to the current profiles by drawing power from the regulator 315. The light engine 340 can determine current profiles respectively for driving the color strings of the LEDs 304 to adjust an intensity or color of light output of the LEDs 304. The light engine 340 can compute the current profiles based on the measured voltage level and in accordance with the color mixing plan 312. The light engine can adjust the intensity or color of the light output as an optical mixture of color outputs individually from the LEDs 304. The light engine 340 can be a set of executable instructions stored in the memory module 310 that can configure the logic component 325 to implement the disclosed functionalities.

In some embodiments, the light engine 340 can adjust the intensity or color of the light output along a correlated color temperature (CCT) curve to achieve a warm dimming effect. For example, a position along the CCT curve characterizing the light output can be a function (e.g., proportional) of the measured voltage level from the voltage measurement component 320. In some embodiments, the light engine 340 can determine an intended light output intensity or output color based on the measured voltage level. In some embodiments, the light engine 340 can identify the current profiles in the color mixing plan 312 for driving the LEDs to match the intended light output intensity or the intended light output color. In some embodiments, the light engine 340 can determine the current profiles to adjust the intensity or color of the light output proportional (e.g., linearly proportional or non-linearly proportional) to the measured voltage level.

In some embodiments, the light engine 340 can use a look-up table in the color mixing plan 312 to compute the current profiles based on the output voltage of the power supply. The light engine 340 can send instructions to the driver circuit 330 to drive the LEDs 304 according to the current profiles. In some embodiments, the light engine 340 can use a predetermined equation in the color mixing plan 312 to compute the current profiles based on the output voltage of the power supply. For example, the predetermined equation can include a linear equation, a logarithmic equation, piecewise linear equations, or a combination thereof. The predetermined equation can take into account the sensitivity of the human eye to light generated by the LEDs 304 in the LED-based light module 300.

In some embodiments, the electronic circuitry 302 can include a power rail 345 coupled to the regulator 315 to supply power to the logic component 325. In some embodiments, the power rail 345 can supply power to the LEDs 304 via the driver circuit 330. In some embodiments, a different power rail (not shown) can supply power to the LEDs 304 from the regulator 315. In some embodiments, the regulator 315 can include at least two subcomponents. A first subcomponent can regulate the power provided to the logic component 325. A second subcomponent can regulate the power provided to the driver circuit 330.

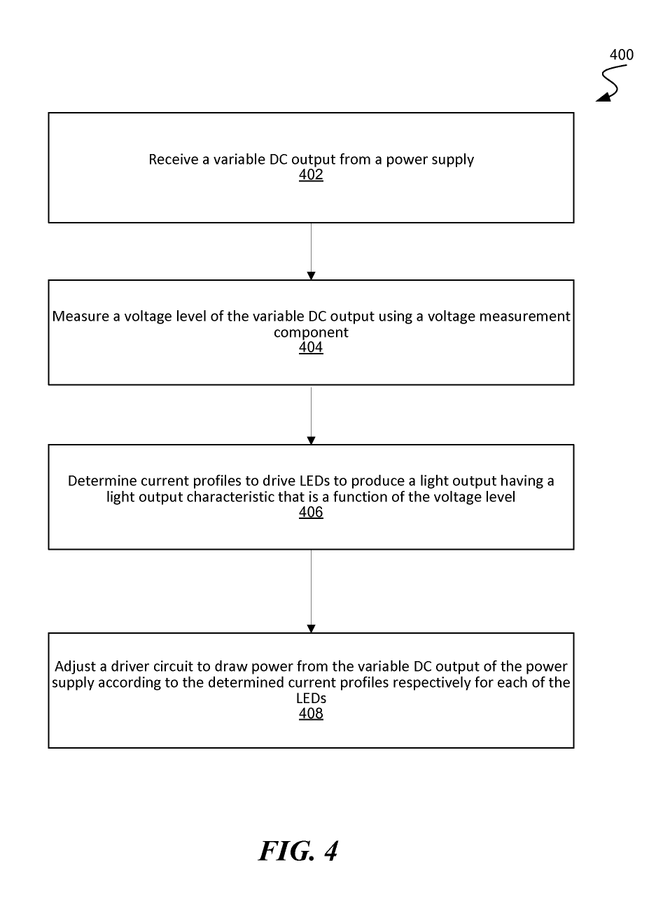

FIG. 4 is a flow chart of a method 400 of operating a LED-based light module (e.g., the LED-based light module 106 of FIG. 1 or the LED-based light module 300 of FIG. 3), in accordance with various embodiments. At block 402, the LED-based light module can receive a variable DC output from a power supply (e.g., the power supply 104 of FIG. 1). In some embodiments, the power supply converts an alternating current (e.g., from the power grid 110 of FIG. 1) to the variable DC output. At block 404, the LED-based light module can measure a voltage level of the variable DC output using a voltage measurement component (e.g., the voltage measurement component 320 of FIG. 3).

At block 406, a logic component (e.g., an analog logic component or a digital logic component), such as the logic component 325 of FIG. 3, of the LED-based light module can determine current profiles to drive LEDs (e.g., the LEDs 108 of FIG. 1 or the LEDs 304 of FIG. 3) to produce a light output having a light output characteristic (e.g., intensity or color) that is a function of (e.g., proportional to) the voltage level. For example, the current profiles can be computed based on a color mixing plan (e.g., the color mixing plan 312 of FIG. 3) stored in a memory module (e.g., the memory module 310 of FIG. 1) of the LED-based light module. At block 408, the LED-based light module can adjust a driver circuit (e.g., the driver circuit 330 of FIG. 3) to draw power from the variable DC output of the power supply according to the current profiles respectively for each of the LEDs. This enables the LED-based light module to dim its light output intensity or its light output color according to a dimmer controlling the power supply.

While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or subcombinations. Also, while processes or blocks are at times shown as being performed in series, these processes or blocks may instead be performed or implemented in parallel, or may be performed at different times. Further, any specific numbers noted herein are only examples.

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The various illustrations and teachings provided herein can also be applied to systems other than the system described above. The elements and acts of the various examples described above can be combined to provide further implementations of various embodiments. Aspects of the disclosed embodiments can be modified, if necessary, to employ the systems, functions, and concepts included in such references to provide further implementations.

These and other changes can be made to the disclosed embodiments in light of the above Detailed Description. While the above description describes certain examples, and describes the best mode contemplated, no matter how detailed the above appears in text, various embodiments can be practiced in many ways. Details of the system may vary considerably in its specific implementation, while still being encompassed by various embodiments disclosed herein. As noted above, particular terminology used when describing certain features or aspects should not be taken to imply that the terminology is being redefined herein to be restricted to any specific characteristics, features, or aspects of the invention with which that terminology is associated. In general, the terms used in the following claims should not be construed to limit the disclosed embodiments to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects or embodiments in any number of claim forms. For example, if only one aspect is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶6 will begin with the words “means for.”) Accordingly, the applicant reserves the right to add additional claims after filing the application to pursue such additional claim forms for other aspects.

What is claimed is:

1. A dimming system comprising:
a light module comprising one or more LEDs;
a power supply configured to provide power as a variable output voltage to the light module;
a dimmer having a human interface component, wherein the dimmer is configured to control the variable output voltage of the power supply within a limited range, wherein the variable output voltage is proportional to an extent of human interaction via the human interface component;
wherein the light module is configured to determine current profiles for driving the LEDs; and
wherein the light module is configured to control the current profiles such that electric currents drawn from the power supply cause the LEDs to produce a light output having an intensity or color that is a function of the variable output voltage of the power supply as measured at the light module.

2. The dimming system of claim 1, wherein the variable output voltage simultaneously provides power to drive the LEDs and provides an absolute voltage level reference to signal a logic component of the LED-based light module to adjust the current profiles to drive the LEDs to achieve the light output intended by a user interacting with the human interface component according to the function.

3. The dimming system of claim 1, wherein the light module further comprises a regulator and a voltage measurement component; and wherein the regulator and the voltage measurement component are both coupled in parallel to the variable output voltage.

4. The dimming system of claim 3, wherein the voltage measurement component is an analog to digital converter.

5. The dimming system of claim 1, wherein the limited range of the power supply has a minimum limit selected to match has a minimum voltage below which the variable output voltage is incapable of sustaining an electronic circuitry of the light module in an operational mode to drive the LEDs.

6. The dimming system of claim 1, wherein the limited range of the power supply has a maximum limit selected to match has a maximum voltage beyond which a logic component or an LED of the light module has a substantial likelihood of malfunction.

7. The dimming system of claim 1, wherein the dimmer is a phase dimmer and wherein the variable output voltage is proportional to a dimming phase of the dimmer.

8. The dimming system of claim 7, wherein the dimmer includes a triode for alternating current (TRIAC) and the dimming phase of the dimmer is proportional to the extent of the human interaction.

9. The dimming system of claim 7, wherein the variable output voltage is linearly proportional to the dimming phase.

10. The dimming system of claim 1, wherein the variable output voltage is linearly proportional to the extent of the human interaction.

11. The dimming system of claim 1, wherein human interface component is a slider and the extent of the human interaction is measured as a position of the slider along a rail of the slider.

12. The dimming system of claim 1, wherein human interface component is a knob and the extent of the human interaction is measured as an amount of radial rotation of the knob.

13. The dimming system of claim 1, wherein the light module further comprises an electronic circuitry to control driving currents supplied to the LEDs; and wherein the electronic circuitry has an operating range that matches the limited range of the power supply.

14. The dimming system of claim 1, wherein the light module is configured to compute the current profiles according to a color mixing plan; and wherein the color mixing plan is a pre-computed model to dictate driving current profiles to produce intended lighting characteristics; and wherein the color mixing plan is generated during a manufacturing stage and stored in a read-only memory.

15. The dimming system of claim 1, wherein the light module is configured to determine the current profiles via an analog logic circuit coupled to a voltage measurement component that is coupled to the variable output voltage of the power supply.

16. The dimming system of claim 1, wherein the dimmer is a push button dimmer that causes the power supply to generate the variable output voltage in discrete steps; and wherein the function maps discrete levels of the variable output voltage to preset light output characteristics.

17. An electronic circuitry for controlling dimming of a light module, comprising:
a regulator that receives a variable output voltage from a power supply; wherein the regulator is configured to provide stable power to components of the electronic circuitry and light emitting diodes (LEDs) that coupled to the electronic circuitry;
a voltage measurement component configured to measure a voltage level of the variable output voltage from the power supply;
a logic component, coupled to the regulator, configured to receive the measured voltage level from the voltage measurement component and to determine current profiles respectively for driving the LEDs to adjust an intensity or color of light output of the LEDs based on the measured voltage level; and
driver circuit to drive the LEDs according to the current profiles by drawing power from the regulator.

18. The electronic circuitry of claim 17, further comprising a power rail coupled to the regulator to supply power to the logic component and the LEDs.

19. The electronic circuitry of claim 17, wherein the logic component is an analog logic component including an amplifier circuit.

20. The electronic circuitry of claim 17, further comprising:
a memory to store a color mixing plan; and
wherein the logic component is a processor configured to determine the current profiles respectively for driving the LEDs to adjust the intensity or color of the light output based on the measured voltage level and the color mixing plan.

21. The electronic circuitry of claim 20, wherein the logic component implements a light engine; and wherein the light engine is configured to compute the current profiles; and wherein the light engine is configured to adjust the intensity of the light output as an optical mixture of outputs individually from the LEDs.

22. The electronic circuitry of claim 21, wherein the light engine is configured to adjust the intensity of the light output along a correlated color temperature (CCT) curve to achieve a warm dimming effect, wherein a position along the CCT curve characterizing the light output is proportional to the measured voltage level from the voltage measurement component.

23. The electronic circuitry of claim 21, wherein the light engine is configured to determine an intended light output characteristic based on the measured voltage level and to identify the current profiles in the color mixing plan for driving the LEDs to match the intended light output characteristic.

24. The electronic circuitry of claim 23, wherein the intended light output characteristic is an intended color or an intended brightness.

25. The electronic circuitry of claim 20, wherein the color mixing plan is a set of associations that specify multiple sets of driving current profiles respectively for driving the LEDs to achieve different light output characteristics under different operational conditions and given different constraints of performance metric constraints.

26. The electronic circuitry of claim 17, wherein the voltage measurement component is attached to an output of the power supply in parallel to the regulator.

27. The electronic circuitry of claim 17, wherein the logic component is configured to determine the current profiles to adjust the intensity or the color of the light output linearly proportional to the measured voltage level.

28. A method of operating an LED-based light module comprising:
receiving a variable direct current (DC) output from a power supply that converts an alternating current (AC) to the variable DC output;
measuring a voltage level of the variable DC output using a voltage measurement component;
computing current profiles to drive LEDs to produce a light output having a color characteristic that is a function of the measured voltage level; and
adjusting a driver circuit of the LED-based light module to draw power from the variable DC output of the power supply according to the current profiles respectively for each of the LEDs.

29. The method of claim 28, wherein the function maps continuous or discrete levels of the voltage level to discrete adjustments of the current profiles, wherein the discrete adjustments correspond to preset light output characteristics.29. The method of claim 27, wherein the function maps discrete or continuous levels of the voltage level to continuous adjustments of the current profiles.
